(19) United States
(12) Patent Application Publication
(10) Pub. No.: US 2021/0383333 A1
(43) Pub. Date: Dec. 9, 2021

(54) METHOD FOR CONTROLLING THE RESOLUTION OF FAULTS IN DISTRIBUTED EQUIPMENT

(71) Applicants: Daniel PEREZ GONZALEZ, BOADILLA DEL MONTE (ES); Ana Belen PEREZ GONZALEZ, BOADILLA DEL MONTE (ES)

(72) Inventors: Daniel PEREZ GONZALEZ, BOADILLA DEL MONTE (ES); Ana Belen PEREZ GONZALEZ, BOADILLA DEL MONTE (ES)

(21) Appl. No.: 17/282,471

(22) PCT Filed: Oct. 5, 2018
(86) PCT No.: PCT/ES2018/070646

§ 371 Date: Apr. 2, 2021

(51) Int. Cl. G06Q 10/00; G06F 16/245; G06Q 20/40; G06Q 30/04; G06Q 10/10; G06Q 10/08; G06Q 10/06; G06Q 30/00; G06Q 30/02; G05B 23/02; H04L 29/08; G07C 5/00

(52) U.S. Cl. CPC G06Q 10/20; G06F 16/245; G06Q 20/40; G06Q 30/04; G06Q 10/1091; G06Q 10/0875; G07C 5/006; G06Q 30/012; G06Q 30/0224; G06Q 30/0282; G05B 23/0259; H04L 67/10; G06Q 10/063114

(57) ABSTRACT

Control procedure for resolving faults in equipment (1) distributed over a plurality of users (2) and requiring the movement of technicians (3) belonging to a technical service that is supervised by a controller (4), which includes various sub-stages by the users (2) each of them on a first terminal (20) connected to the internet (100), and on which a first application runs; various sub-stages by the technicians (3), provided with a second terminal (30) each equipped with a geolocator (33), connected to the internet (100) and on which a second application runs and various sub-stages by a controller (4), who has the central server (40) connected to the internet (100) to communicate with the first terminals (20) and with the second terminals (30) to control the technicians' schedules and to give them support and speed up the work.

### OBJECT OF THE INVENTION

This invention refers to a control procedure for the resolution of faults in distributed equipment, understood as those that are used by multiple users and that require the displacement of technicians belonging to a technical service that is supervised by a controller.

### BACKGROUND TO THE INVENTION

Servicing faults in various types of equipment (cool stores, air conditioning equipment, lifts, etc.) is carried out by specialised technicians belonging to technical service organisations, who go to repair the faults in equipment owned by, or in the possession of, users when there is a notification of a fault in them.

Currently, there is a problem in the agility of the service to users, since the resolution times for the fault cannot be precisely monitored, this includes the technician's travel time which usually leads to the number of technicians needed being underestimated, generating delays. On other occasions, delays are generated by unnecessary loss of technician time.

These problems are solved using the process of the invention.

### INVENTION DISCLOSURE

The invention's control procedure for the resolution of faults in distributed equipment has a configuration that guarantees that the time spent in resolving the fault is well matched to that really necessary, avoiding delays, and that also guarantees the collection of payment for the service and improves the resolution of problems or doubts during the repair.

The procedure is carried out on equipment distributed over a plurality of users and that requires the displacement of technicians belonging to a technical service that is supervised by a controller, and according to the invention it includes the following sub-stages by the users on a first terminal, each of them connected to the internet, and on which a first application runs:
recording of the equipment to be maintained by the first application, including the type of equipment and its location (this is done once),
if there is a fault in a piece of equipment, the entry into the first application of a notification of a fault by selecting the faulty equipment in the first application, a description of the fault, and selection of whether it requires urgent assistance (in less than 4 hours for example) or not, in 24 hours for example,
generation and sending of a work order by the first application, including the description of the fault and the request for urgent assistance or not, to a central server of the controller,
reception by the first application of a first payment order to cover the travel and the first hour of service from the controller's central server,
approval by the specific user, through their first application, of the payment of the first payment order, which implies the realisation of the payment,
reception through the first application of the information on the time and date on which the technician is going to attend to resolve the fault, sent from the controller's central server,
reception through the first application of the cost prepared using the information provided by the technician, from the central server,
reception by the first application of a second payment order for the repair from the controller's central server, once the repair carried out has been approved,
approval by the user, through their first application, of the payment of the second payment order, which implies the realisation of the payment,
reception of the invoice from the controller's central server through the first application;

including the following sub-stages by the technicians, provided with a second terminal each with a geolocator (GPS, etc.), connected to the internet and on which a second application runs:
reception from the controller's central server of the work orders corresponding to the equipment involved through the second application, including, as a minimum, information on location, date, time and equipment,
displacement to the location of each affected piece of equipment, and request by the second application to record the precise time of arrival,
geolocation of the technician's terminal by the geolocator and the second application,
check by the second application that the distance between the geolocation carried out and the location coordinates of the equipment corresponding to the work order does not exceed a maximum value, and the sending of the precise time of arrival (date and time), if so, to the controller's central server,
evaluation of the fault by the technician through their actions and/or consultation of manuals and technical information through the second application installed on the second terminal,
communication with the controller to report the diagnosis and its solution through the chat integrated into the second application and the central server,
check, through the inventory integrated into the second application, that a spare is available locally (in the technician's van or vehicle, which also allows all the spare parts that it carries to be inventoried and labelled).
recording by the second application of the part to be used and the estimated time to carry out the repair, and sending it to the controller's central server,
reception of the quote or estimate from the controller's central server by the second application, so that the technician communicates the problem, the solution and its price to the user,
carrying out the repair,
recording the user's approval (signature on the electronic delivery note) once the repair is complete through the second application to proceed with the payment,
request to record the precise time of the technician's departure in the second terminal,
geolocation of the second terminal by the geolocator and the second application,
check by the second application that the distance between the geolocation carried out and the location coordinates of the equipment corresponding to the work order does not exceed a maximum value, and the sending of the precise time of departure (date and time), if so, to the controller's central server;

including the following sub-stages by the controller, who has the central server connected to the internet to communicate with the first terminals and with the second terminals:
reception of work orders generated by the first applications of the first user terminals,
creation of the technicians' schedules and assignment of the work orders received to each of them,
communication to the users of the day and time on which the technician will attend to the corresponding work order,
reception by the central server of the verified location of the technicians (by the corresponding second terminal) and the precise time of their arrival for the repair of each faulty piece of equipment from each technician's second terminal,
reception, reply and recording (they are stored) of the technicians' communications reporting the diagnosis and their solution to the faults through the chat integrated into the second application of each second terminal and the central server,
creation and sending of the quote or estimate by the central server to the first user terminal and the corresponding technician second terminal, with an estimate of the repair time for the fault,
reception by the central server of the user's agreement to the repair from the second terminal,
reception by the central server of the user's approval of the repair from the second terminal, once the repair has been carried out, by their signing of the electronic delivery note,
generation of the payment order and invoice, and the sending of the invoice from the central server to the customer's first terminal,
reception by the central server of the verified location of the technicians (by the corresponding second terminal) and the precise time of their departure after the repair of each faulty piece of equipment from each technician's second terminal,
recording of the time spent on the repair by the central server, by comparing the precise time of arrival and the precise time of departure,
recording by the central server of the comparison of the time spent on the repair with the time established to carry out the repair, so that the intervention is recorded in each technician's profile, as well as the arrival and departure time and the effectiveness. As every piece of equipment is assigned an identifier, each intervention is recorded by the central server and the user can have access to that information in order to be able to see what the user spends on repairs for each piece of equipment at the user's various locations.

Therefore, the invention allows, not only the time and effectiveness of repairs and their payment to be controlled, but also the recording of conversations with the technician, the collection of payment and cooperation in the technicians' inventory of spare parts, the improvement of the technicians' agility in their response and their attention.

In this document, the controller is understood to be one or more people who carry out the sub-stages individually or collectively, simultaneously or not (Dispatcher, purchasing manager, administration manager, technical coordinator, etc.), who can communicate with each other through the chat integrated into the central server, which can also include one or more terminals.

### BRIEF DESCRIPTION OF THE DRAWINGS

FIG. 1 shows a diagram with the participating elements in the process of the invention.

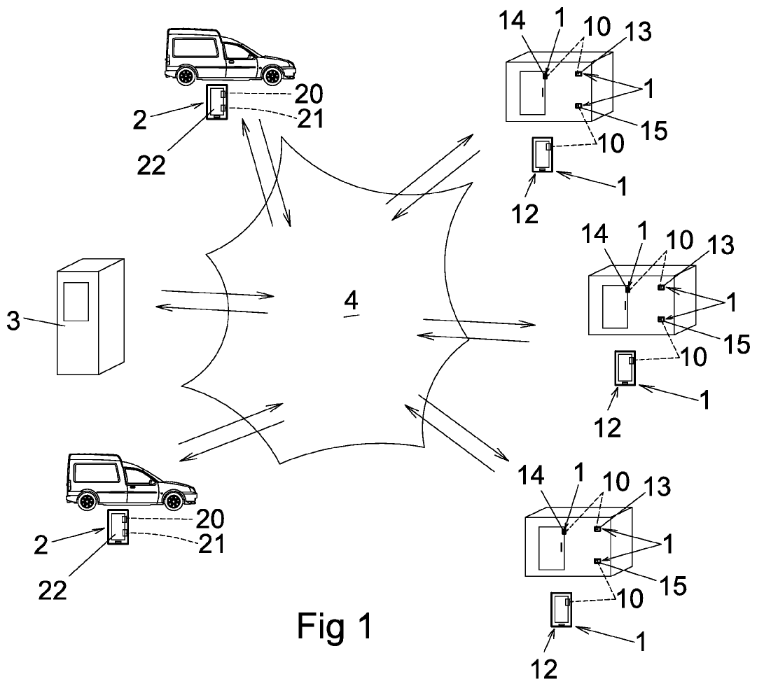

### DESCRIPTION OF A PRACTICAL IMPLEMENTATION OF THE INVENTION

The invention's control procedure for resolving faults in distributed equipment (1) (the property of a plurality of users (2) and that requires the displacement of technicians (3) belonging to a technical service that is supervised by a controller (4)) includes the following sub-stages by the users (2) on a first terminal (20), each of them connected to the internet (100), and on which a first application runs:
record of the equipment (1) to be maintained in the first application, including the type of equipment (1) and its location (this is done once),
if there is a fault in a piece of equipment (1), the entry into the first application of a notification of a fault by selecting the faulty equipment (1) in the first application, a description of the fault, and selection of whether or not it requires urgent assistance,
generation and sending of a work order by the first application, including the description of the fault and the request for urgent assistance or not, to a central server (40) of the controller's (4),
reception by the first application of a first payment order to cover the travel and the first hour of service from the controller's (4) central server (40),
approval by the specific user (2), through their first application, of the payment of the first payment order, which implies the realisation of the payment
reception, through the first application, of the information on the time and date on which the technician is going to attend to resolve the fault, sent from the controller's (4) central server (40),
reception, through the first application, of the cost calculated using the information provided by the technician, from the central server (40),
reception by the first application of a second payment order for the repair from the controller's (4) central server (40), once the repair carried out has been approved,
approval by the user (2), through their first application, of the payment of the second payment order, which implies the realisation of the payment
reception of the invoice from the controller's (4) central server (40) through the first application;

including the following sub-stages by the technicians (3), each provided with a second terminal (30) equipped with a geolocator (33) (GPS, etc.), connected to the internet (100) and on which a second application runs:
reception from the controller's (4) central server (40) of the work orders corresponding to the equipment (1) involved through the second application, including, as a minimum, information on location, date, time and equipment (1),
displacement to the location of each affected piece of equipment (1), and request by the second application to record the precise time of arrival,
geolocation of the technician's terminal by the geolocator (33) and the second application,
check by the second application that the distance between the geolocation carried out and the location coordinates of the equipment (1) corresponding to the work order does not exceed a maximum value, and the sending of the precise time of arrival, if so, to the controller's (4) central server (40),
evaluation of the fault by the technician (3) through their actions and/or consultation of manuals and technical information through the second application installed on the second terminal (30),
communication with the controller (4) to report the diagnosis and its solution through the chat integrated into the second application and the central server (40),
check through the inventory integrated into the second application that a replacement is available locally (in the technician's van or vehicle (35)),
recording by the second application of the part to be used and the estimated time to carry out the repair, and sending it to the controller's (4) central server (40),
reception of the quote or estimate from the controller's (4) central server (40) by the second application,
carrying out the repair.
recording the user's (2) approval once the repair is complete through the second application to proceed with the payment,
request to record in the second terminal (30) the precise time of the technician's (3) departure,
geolocation of the second terminal (30) by the geolocator (33) and the second application,
check by the second application that the distance between the geolocation carried out and the location coordinates of the equipment (1) corresponding to the work order does not exceed a maximum value, and the sending the precise time of departure, if so, to the controller's (4) central server (40);

including the following sub-stages by the controller (4), who has the central server (40) connected to the internet (100) to communicate with the first terminals (20) and with the second terminals (30):
reception of work orders generated by the first applications of the first user terminals (20),
creation of the technicians' (3) schedules and assignment of the work orders received to each of them,
communication to the users (2) of the day and time on which the technician will attend to the corresponding work order,
reception by the central server (40) of the verified location of the technicians (3) and the precise time of their arrival for the repair of each faulty piece of equipment (1) from each technician's (3) second terminal (30),
reception, reply and recording of the technicians' (3) communications reporting the diagnosis and their solution to the faults through the chat integrated into the second application of each second terminal (30) and the central server (40),
creation and sending of the quote or estimate by the central server (40) to the first user terminal (20) and the corresponding technician second terminal (30), with an estimate of the repair time for the fault,
reception by the central server (40) of the user's (2) agreement to the repair from the second terminal (30),
reception by the central server (40) of the user's (2) approval of the repair from the second terminal (30), once the repair has been carried out,
generation of the payment order and invoice, and the sending of the invoice from the central server (40) to the customer's first terminal (20),
reception by the central server (40) of the verified location of the technicians (3) (by the corresponding second terminal (30)) and the precise time of their departure after the repair of each faulty piece of equipment (1) from each technician's (3) second terminal (30),
recording by the central server (40) of the time spent on the repair, by comparing the precise time of arrival and the precise time of departure,
recording by the central server (40) of the comparison of the time spent on the repair with the time established to carry out the repair.

It has been foreseen that the maximum value of the distance between the geolocation carried out and the location coordinates of the equipment (1) corresponding to the work order is 100 metres to allow for possible geolocation positioning errors.

The invention optionally provides a sub-stage by the controller (4) for controlling the local inventory of the technicians (3), including:
periodic listing (weekly, for example) by the central server (40) of the spare parts used by each technician (3),
consultation in the price databases of various suppliers of the spare parts by the central server (40) to find the cheapest, and
purchasing of spare parts through the central server (40).

There is also an optional sub-stage for the users (2) to consult their data on their repairs or equipment (1) through the first application installed in the corresponding first terminal (20), which includes:
sending to the central server (40) a query request including the equipment (1) identifier, and
reception of the information, sent from the central server (40);

the data on their repairs or equipment (1) including one or more of the following:
repair history for each piece of equipment (1),
repair history for each location,
payment history for each location,
guarantees for the equipment (1) if it is new, (know the time remaining on the equipment guarantee)
guarantees for the repairs carried out by the technicians (3), (for example 60 working days or 1 year depending on the parts affected); and

including a stage of sending the requested data by the controller (4) through the central server (40).

The procedure, optionally or additionally, can also include one or more additional sub-stages by the users (2) on their first terminal (20) selected from:
communication with the controller (4) to report an incident or information of interest through the chat integrated into the first application and the central server (40),
reception of promotions and discounts based on business volume,
sending of feedback on the service, technician, etc., and
submission of claims or inquiries about equipment (1) guarantees,

including the following corresponding sub-stages by the controller (4) through the central server (40):
reception, reply and recording of communications with the users (2),
sending of promotions and discounts based on business volume,
reception of feedback on the service, technician, etc., and
response to claims and inquiries about equipment (1) guarantees.

Further, the procedure, optionally or additionally, can also include one or more additional sub-stages by the technicians (3) on their second terminal (30) selected from:
access to the list of spare parts for the various pieces of equipment (1),
request for spare parts and materials, and consultation of such requests,
consultation of their weekly activity (work done, hours worked, etc.),
reception of their payments (payroll),
reception of financial incentives (for volume, work with no incidents, etc.),
consultation of their assessments and those of the company,

including the following corresponding sub-stages by the controller (4) through the central server (40):
storage and download to the technicians (3) of the equipment (1) spare parts lists,
reception of requests for spare parts and materials from technicians (3), and response to inquiries about those requests,
response to the inquiries about the weekly activity of the technicians (work performed, hours worked, etc.)
sending of the technician payments (3) (payroll management),
sending of the financial incentives (for volume, work with no incidents, etc.), and
response to the inquiries about individual assessments (explain) of each technician (3) and of the company.

In addition, the method, optionally or additionally, can also include an additional sub-stage by the controller (4) through the central server (40) including the control of the vehicle fleet (35) by means of one or more of the following actions:
generation of notification of the need for maintenance or repair of vehicles (35) according to their mileage or if they suffer a breakdown, and
generation of notification of the need to carry out inspections of the vehicles (35) when they are due.

Having sufficiently described the nature of the invention, as well as the way it is carried out in practice, it should be noted that the provisions given above and represented in the attached drawings are susceptible to detailed modifications as long as they do not alter the fundamental principle.

1. Control procedure for resolving faults in equipment (1) distributed among a plurality of users (2) and that requires the displacement of technicians (3) belonging to a technical service that is supervised by a controller (4) characterised by the inclusion of the following sub-stages by the users (2) on a first terminal (20), each of them connected to the internet (100), and on which a first application runs:
record of the equipment (1) to be maintained in the first application, including the equipment (1) type and location,
if there is a fault in a piece of equipment (1), the entry into the first application of a notification of a fault by selecting the faulty equipment (1), a description of the fault, and selection of whether or not it requires urgent assistance,
generation and sending of a work order by the first application, including the description of the fault and the request for urgent assistance or not, to a central server (40) of the controller's (4),
reception by the first application of a first payment order to cover the travel and the first hour of service from the controller's (4) central server (40),
approval by the specific user (2), through their first application, of the payment of the first payment order,
reception, through the first application, of the information on the time and date on which the technician is going to attend to resolve the fault, sent from the controller's (4) central server (40),
reception, through the first application, of the cost calculated using the information provided by the technician, from the central server (40),
reception by the first application of a second payment order for the repair from the controller's (4) central server (40), once the repair carried out has been approved,
approval by the user (2), through the first application, of the payment of the second payment order,
reception of the invoice from the controller's (4) central server (40) through the first application;
including the following sub-stages by the technicians (3), each provided with a second terminal (30) equipped with a geolocator (33), connected to the internet (100) and on which a second application runs:
reception from the controller's (4) central server (40) of the work orders corresponding to the equipment (1) involved through the second application, including, as a minimum, information on location, date, time and equipment (1),
displacement to the location of each affected piece of equipment (1), and request by the second application to record the precise time of arrival,
geolocation of the technician's terminal by the geolocator (33) and the second application,
check by the second application that the distance between the geolocation carried out and the location coordinates of the equipment (1) corresponding to the work order does not exceed a maximum value, and the sending of the precise time of arrival, if so, to the controller's (4) central server (40),
evaluation of the fault by the technician (3) through their actions and/or consultation of manuals and technical information through the second application installed on the second terminal (30),
communication with the controller (4) to report the diagnosis and its solution through the chat integrated into the second application and the central server (40),
check through the inventory integrated into the second application that they have a replacement available locally,
recording by the second application of the part to be used and the estimated time to carry out the repair, and sending it to the controller's (4) central server (40),
reception of the quote or estimate from the controller's (4) central server (40) by the second application,
carrying out the repair.
recording the user's (2) approval once the repair is complete through the second application to proceed with the payment,
request to record on the second terminal (30) the precise time of the technician's (3) departure,
geolocation of the second terminal (30) by the geolocator (33) and the second application,
check by the second application that the distance between the geolocation carried out and the location coordinates of the equipment (1) corresponding to the work order does not exceed a maximum value, and the sending of the precise time of departure, if so, to the controller's (4) central server (40);
including the following sub-stages by the controller (4), who has the central server (40) connected to the internet (100) to communicate with the first terminals (20) and with the second terminals (30):
reception of work orders generated by the first applications of the first user terminals (20),
creation of the technicians' (3) schedules and assignment of the work orders received to each of them,
communication to the users (2) of the day and time on which the technician will attend to the corresponding work order,
reception by the central server (40) of the verified location of the technicians (3) and the precise time of their arrival for the repair of each faulty piece of equipment (1) from each technician's (3) second terminal (30),
reception, reply and recording of the technicians' (3) communications reporting the diagnosis and their solution to the faults through the chat integrated into the second application of each second terminal (30) and the central server (40),
creation and sending of the quote or estimate by the central server (40) to the first user terminal (20) and the corresponding technician second terminal (30), with an estimate of the repair time for the fault,
reception by the central server (40) of the user's (2) agreement to the repair from the second terminal (30),
reception by the central server (40) of the user's (2) approval of the repair from the second terminal (30), once the repair has been carried out,
generation of the payment order and invoice, and the sending of the invoice from the central server (40) to the customer's first terminal (20),
reception by the central server (40) of the verified location of the technicians (3) and the precise time of their departure after the repair of each faulty piece of equipment (1) from each technician's (3) second terminal (30),
recording by the central server (40) of the time spent on the repair, by comparing the precise time of arrival and the precise time of departure,
recording by the central server (40) of the comparison of the time spent on the repair with the time established to carry out the repair.

2. The control procedure for resolving faults in distributed equipment (1) according to claim 1 characterised by the maximum distance between the geolocation carried out and the location coordinates of the equipment (1) corresponding to the work order being 100 metres

3. The control procedure for resolving faults in distributed equipment (1) according to claim 1 characterised by including a sub-stage by the controller (4) to control the local inventory of the technicians (3), including:
periodic listing by the central server (40) of the spare parts used by each technician (3),
consultation in the price databases of various suppliers of the spare parts by the central server (40),
purchasing of spare parts through the central server (40).

4. The control procedure for resolving faults in distributed equipment (1) according to claim 1 characterised by including a sub-stage by users (2) for consulting their data on their repairs or equipment (1) through the first application installed on the first corresponding terminal (20), which includes:
sending to the central server (40) a query request including the equipment (1) identifier,
reception of the information, sent from the central server (40);
the data on their repairs or equipment (1) including one or more of the following:
repair history for each piece of equipment (1),
repair history for each location,
payment history for each location,
equipment guarantees (1) if they are new, and
guarantees for the repairs carried out by the technicians (3);
including a stage of sending the requested data by the controller (4) through the central server (40).

5. The control procedure for resolving faults in distributed equipment (1) according to claim 1 characterised by it including one or more additional sub-stages by users (2) on their first terminal (20) selected from:
communication with the controller (4) to report incident or information of interest through the chat integrated into the first application and the central server (40),
reception of promotions and discounts based on business volume,
sending of feedback on the service or technician,
submission of claims or inquiries about equipment (1) guarantees,
including the following corresponding sub-stages by the controller (4) through the central server (40):
reception, reply and recording of communications with the users (2),
sending of promotions and discounts based on business volume,
reception of feedback on the service, technician, etc., and
response to claims and inquiries about equipment (1) guarantees.

6. The control procedure for resolving faults in distributed equipment (1) according to claim 1 characterised by the inclusion of one or more additional sub-stages by technicians (3) on their second terminal (30) selected from:
access to the list of spare parts for the various pieces of equipment (1),
request for spare parts and materials, and consultation of such requests,
consultation of their weekly activity,
reception of their payments,
reception of financial incentives, and
consultation of their assessments and those of the company,
including the following corresponding sub-stages by the controller (4) through the central server (40):
storage and download to the technicians (3) of the equipment (1) spare parts lists,
reception of requests for spare parts and materials from technicians (3), and response to inquiries about those requests,
response to the technicians' weekly activity inquiries,
sending the technicians' (3) payments,
sending the technicians' financial incentives,
response to the inquiries about the individual assessments of each technician (3) and those of the company.

7. The control procedure for resolving faults in distributed equipment (1) according to claim 1 characterised by the inclusion of an additional sub-stage by the controller (4) through the central server (40) comprising the control of the vehicle fleet (35) by means of one or more of the following actions:
generation of notification of the need for maintenance or repair of vehicles (35) according to their mileage or if they suffer a breakdown, and
generation of notification of the need to carry out inspections of the vehicles (35) when they fall due.
